(19) United States
(12) Patent Application Publication
(10) Pub. No.: US 2003/0023685 A1
(43) Pub. Date: Jan. 30, 2003

(54) Data processing system for mapping a collaborative reasoning process

(75) Inventors: Phillip A. Cousins, Miami Beach, FL (US); Diane L. Downs, Miami Beach, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cousins Downs Partnership, Miami Beach, FL (US)

(21) Appl. No.: 09/836,886

(22) Filed: Apr. 17, 2001

(51) Int. Cl. G06F 15/16

(52) U.S. Cl. 709/205; 705/10

(57) ABSTRACT

A technique for using a data processing system to measure organizational change and aid in decision-making, especially with respect to collaborative group decisions. The system is generalizable to any situation to improve information use, decision making, and measurement by creating a unit of analysis that is constant across diverse information sets. A process implemented according to the invention is based upon an initial interview approach that is used gather data on the topics under question. For example, if the application is to expedite decision-making processes relating to organizational change, the interview process asks a stratified sample of people in an organization open-ended questions. The interview responses are then represented in a unique data structure format to facilitate subsequent data collection, analysis and visualization in the context of an integrated, on-line active decision making and feedback system. The invention also specifies a graphical model and interface for collecting individual perceptions and factual data to support those perceptions, and then visualizing relationships and measuring the variance across groups or over time between these perceptions and the factual data using the same graphical model.

### BACKGROUND OF THE INVENTION

Those having responsibility for making decisions in a modern business enterprise face unprecedented demands. Because of the speed at which commerce continues to accelerate, it is essential that critical decisions, especially those relating to organizational changes, occur as rapidly as possible and using as much information that can be trusted to be accurate as possible. Needs often include the ability to quickly assess the state of the entire enterprise, accelerate detection and correction of false assumptions, build cross-functional alignments, and manage constrained resources.

Certain data processing systems have been employed in the prior art to assist with collaborative decision making. For example, U.S. Pat. No. 5,995,951 issued to Ferguson describes a system that operates within a network of computers allowing a number of individuals to collaborate in a decision making process. The system allows for submission of group proposals to a central server by users located at client computers. The system then solicits from the users selections of proposals they believe best fit a solution to a problem. The described method also involves determining at the central server a modified narrow group of proposals selected in response to suggestions made by the users in consolidating the selection of modified sets of statements about the proposals.

U.S. Pat. No. 6,078,924 issued to Ainsbury describes another online decision making system. This system provides a user the understanding needed to execute rapid and knowledgeable decision making with respect to market based criteria. An information platform retrieves data using collection agents from both external and internal sources; classifies and stores the retrieved data; and allows for browsing and reporting of data in various formats.

U.S. Pat. No. 5,983,214 issued to Lang et al. relates to a system that processes collaborative input data to determine rating functions that are indicative of the value of information. The system is primarily concerned with automating the creation of databases for web based search engines.

Certain computer software products are also available for assisting with decision making. For example, the Analytica Decision Engine is a software program available from a company called Lumina. Analytica provides a framework for creating, analyzing, and communicating quantitative business models. The product can be embedded into applications or web servers.

Companies such as Aliah and Decide Now provide web based services and computer software that enable an enterprise and/or individual to make a decision based upon certain supplied criteria.

### SUMMARY OF THE INVENTION

Recognition of the Problems Inherent in the Prior Art

Certain key influences can be observed in the patterns of failure documented for these prior art automated decision systems. These can include: information overload, not providing access to relevant information without exhaustive search, not prioritizing across converging opportunities, technology tools that are unable to process rapidly increasing demands, the dynamics of business work accelerated by merger and acquisition activity, business knowledge lost by downsizing, stores of information that are not compatible with one another because of changes in technology infrastructures over time, the need for time critical decisions requiring rapid chum of fresh, recent compiled data, and others.

The marketplace for automated decision making systems offers a variety of precisely focused tools. However, the narrow focus of such tools can often stem from a narrow research base supporting the tool. This is not to say that these types of tools have no use, but that their use is for specified situations or process. None of them address organizational definition, but rather select traditional business processes to illuminate with new methods. These tools have identifiable limits that can appear in any combination:

too complicated for people to use

consultant-dependent for long periods of time

not dynamic or scalable

not cross-functional in nature or scope

incompatible with existing corporate programs and systems

not designed to give continuous feedback to senior execs.

The present invention addresses the above limitations in a number of ways.

First, it employs a constant basis and format for visual displays. The metrics or data on display may originate from different sources and audiences but the constant visual graphic format bridges these differences. The visual format is simple and illustrative, and can be effectively used by a variety of people after only a short period of training or exposure to the system.

The common graphical format similarly lends itself to implementation in a data structure format that can be stored, analyzed, compiled, categorized and reviewed quickly and effectively across a number of different organizational areas or user criteria.

The invention uses computer industry standard products to run and is itself designed to pull information from various sources using conventions embedded in object oriented software.

The invention also uses the Internet and preferably web based architecture to enable delivery up-to-the-moment visual displays of the process to a set of users located at dispersed sites. This not only permits viewing of the collected information and generated reports for all decision makers in a diverse organization, but allows the use of built-in security and privacy of access features of such a system, while at the same time addressing speed and scalability concerns.

In the context of an organizational change decision making, measurement and feebback system, the definition of “organization” is generalizable, so that the visual representations can display data from any organization or organizational function.

Continuous use of the invention can enable decision makers to see the whole organization in action as images and the underlying data are refreshed on demand. The continuous use will display the impact of actions taken in pursuit of organizational goals and therefore lessen the time to discovery of the need for a course correction, thereby saving resources.

The invention respects and includes divergent points of reference, it guides thinking and acting, it establishes a common frame of reference for all members of an organization, it supports creativity for individuals and groups, and it reflects rather than minimizes the unique qualities of the organization that make the organization unique.

It is in fact the ability of the system to render maps that show the interaction of the above properties in a uniform schematic representation, or map, that differentiates the system from prior art, and enables the detection of patterns of collective reasoning and interactive collaborative group decision making, also known as organizational learning.

Technical Approach of the Present Invention

The present invention seeks to provide a data processing system to aid decision-making, especially with respect to decisions relating to organizational change. The system is generalizable to any situation to improve information use, decision making, and measurement by creating a unit of analysis that is constant across diverse information sets and organizational types.

A process implemented according to the invention is based upon an initial interview approach that is used to gather data on the topics under question. For example, if the application is to expedite decision-making processes relating to organizational change, the interview process asks a stratified sample of people in an organization open-ended questions about that topic.

The interview responses are then represented in a unique data structure format to facilitate subsequent analysis and visualization in the context of an integrated, on-line active decision making system.

The invention also specifies a graphical model and interface for collecting individual perceptions and factual data that supports those perceptions, and then visualizing relationships between these perceptions and facts using the same graphical model.

More particularly, the present invention is a process implemented in a network of computers for interactive collaborative decision-making. The process includes an initial step of specifying elements of a participant survey process. The survey elements preferably incorporate an open-ended question model. The question model, however, encourages responses that can be categorized in specific, predefined ways.

Responses to the survey process can thus be stored as data objects tailored to fit a particular format, which preserves observed interrelationships between different subject matter areas that pertain to the determinants of human reasoning. The data objects representing these different determinants or influences on the decision making process are referred to as influence objects.

An automatic logic model process is specified according to decision logic functions used to analyze the influence objects. The automatic logic model process permits the data processing system to continuously analyze the survey response data in this form to provide a compiled collaborative group view regarding the decision.

Because the decision making process is thus automated, a real time interactive display of the compiled decision process and specific details of the elements influencing that decision is possible.

In a preferred implementation for organizational decision making, labels for the influence objects are selected from a lexicon consisting of key words for leadership, marketing, strategy, finance, operations, sales, structure, culture, development, staffing and customer activities.

In connection with further preferred features of the present invention, a dynamic multidimensional array is provided for the purpose of representing the influence objects. Specifically, the influence objects are arranged in a fixed spatial display with respect to one another, referred to as an influence map. In the preferred embodiment, this pattern for visualizing the determinants has been statistically derived from a frequency distribution of the interactions reported among the determinants through a scoring procedure.

In the corresponding visual display of the influence map, the configuration of influence objects may be displayed as spheres. The spheres may be further defined and/or rendered through the use of a survey response state mechanism that takes a familiar form such as a traffic light. The traffic light paradigm may, for example, indicate the colors red, yellow and green as representing the range of responses to questions, indicating, respectively, a state of tasks, urgency, uncertainty with the status quo or accomplishments. No choice generates a neutral—blue—color, which indicates that no data was reported.

In yet another aspect of the invention, complex relationships among the determinants of human reasoning in organizations can be represented as links between -the influence objects. This provides an additional, powerful representational feature for visualizing the interaction effects of subjective judgments with factual evidence reported by different groups and compared data compiled for the organization as a whole.

At a first level of data analysis, the links provide a visual representation of the context or some relationship between influence objects in compiled representations. The links may represent the state of relationships between various activities or events and may further specify the rate, level or direction of interactivity between them. A scoring matrix provides direction for locating links between influence objects, and hence the observed influences between two different determinants of organizational change.

As an “activity level” indicator, the link displays appearing on the respective map can indicate a number of identified links as a line associated with a varying thickness. This format provides a way to compile group data using proportional thickness of the link to indicate how many responses fall into a particular category.

Links may take various graphical forms as well. For example, an individual positive link (or “connection”) can be represented as a black line with an arrow as in the visual representation of the map. An individual negative link (or “block”) can be represented as a black “hammer”. The compiled maps may be used to answer the question, is the whole greater than the sum or its parts. Where and how often to the positive values (accomplishments) out weigh the negative ones (issues)?

The influence object model also lends itself to representing and visualizing the interaction of two or more data change perception data sets. For example, a reflection map may compile individual perception maps, and represent the responses graphically in a scheme where the spheres are colored as bar charts to indicate the number of responses of a particular type or a computed value for each influence object.

A hemisphere map permits the user to gauge a level of congruence or divergence between two different data sets. The hemisphere map divides each graphical sphere by its vertical diameter into two hemispheres, with a hemisphere devoted to each data set. Within the hemisphere, a colored bar chart may be used to indicate the compiled survey results.

A circuit board map may compile individual factual data supporting perceptions into a compiled representation as well. The compiled connections and blocks are rendered as arrows, lines or hammers with varying thickness or color.

Furthermore, the process may categorize response data by participant class. Functions can then be implemented within the system to allow participants from one class of users to review survey results provided by participants of a different class, without revealing individual identities.

Security features provided by the distributed computing model provide many advantages. For example, participation is encouraged because individual's identities and responses may be kept private, and various-sized organizations can use and benefit from the technology.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level process flow diagram for a decision system implemented according to the invention.

FIG. 2 is a diagram of one particular implementation of the influence map that is used for data visualization.

FIG. 3 is an extract of a scoring matrix illustrating how the relationships between the influence objects may be defined.

FIG. 4 is an extract of a neighborhood matrix illustrating the relationships between influence objects and the arrangement of the influence map array

FIG. 5 is a list of typical survey sample questions and provided responses.

FIG. 6 is one embodiment of a perception map that makes use of the influence map structure showing survey responses compiled for one person.

FIG. 7 is a reflection map that is used to combine individual perceptions into a group view, also based upon the influence map model,.

FIG. 8 is a circuit board map further providing an additional visualization that is used to show the perception evidence cited in the survey in conjunction with individual perceptions.

FIG. 9 is a hemisphere map that permits comparison of perceptions.

FIG. 10 is an opportunity map that is used to reveal positions on the influence map where new actions could be taken, combined with a visualization technique used to examine the interaction effects among display layers.

FIG. 11 is an action map that is used to combine the tasks that individuals have agreed to undertake, used to examine their interaction effects among actions and with the other layers of data.

### DETAILED DESCRIPTION OF A PREFERRED EMBODIMENT

1. Introduction and Overview

The present invention is a system to measure and represent aspects of a collaborative reasoning process. The specific embodiments described herein are optimized for a decision-making process relating to organizational change; however, it should be understood that the principles employed may be applied to build models of other collaborative reasoning processes.

The system is automated via the use of a data processing system, preferably a distributed data processing system, using a network client-server processor or peer to peer model such as is commonly employed in the Internet and Intranets. Such a model permits ease of implementation on web-based clients and servers so that users of the system may be located at computer nodes in any portion of a wide area computer network.

The system incorporates different types of tools in an object oriented data processing environment. These tool types include:

interface—tools that permit users to interact with the system

data structures—used to store, retrieve send and display data

objects—used to perform operations with the data structures

agents—used to learn and execute system tasks

Certain discrete types of data structure components are used by the system to support the interpretive agent procedures such as an analyzer, viewer controls, output results and furnish inter-operative rules.

The preferred embodiment of the system also includes a graphical web-based function, which displays certain representations of data objects as maps, as described below. This map display function can, for example, be integrated into a JAVA based program for data collection that also provides an automated self-service survey instrument used at the client computers.

The interactive, adaptive design of the display architecture means that organization maps display output of data, with embedded links to an online agent that functions as an intelligent guide to navigate through different views of the data using the same familiar map (agent functions). Users have the ability to modify various items to provide interpretive guidance, or generate new or updated input for the system. Users can validate and test the accuracy of their perceptions and the validity of so called “factual” data. Maps comparing the interaction of two data sets (perceptions and/or facts) can then be used to measure the change process.

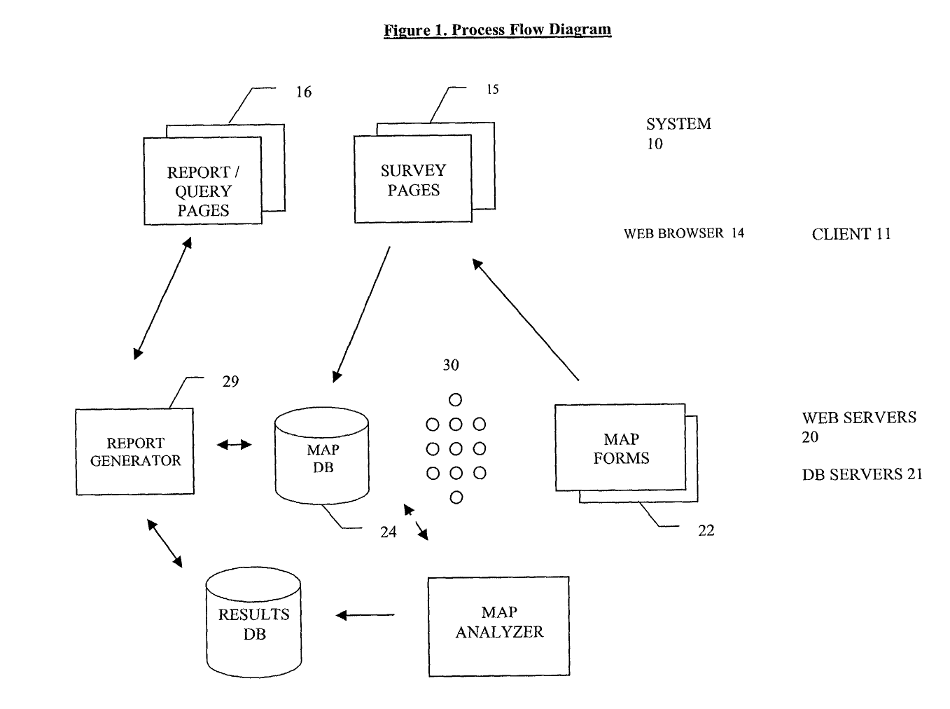

Now with reference more particularly to the accompanying drawings, a preferred embodiment of the system 10 is shown in FIG. 1. The system 10 is implemented in a distributed data processing environment that includes client computers 11 and server computers 12. The client 11 and server 12 computers may typically be arranged as web-enabled computers such that the clients 11 execute web browser programs 14 and the server computers include both web servers 20 and data base servers 21. The web servers 20 and accompanying data base servers 21 may be further implemented using commonly available distributed data processing environments and tools such the distributed database products available from Oracle™, Inc. and the web enabled application server products available from Netscape™ Communications, Inc.

The web browser 14 permits a user to view survey questions and provide responses thereto using the survey web pages 15. The user may also query the system and receive reports via the report/query web pages 16. The survey pages 15 and report pages 16 are typically implemented using eXtensible Markup Language (XML) or other appropriate page definition, transmission, validation, and interpretation language.

The servers 20 and 21 collectively implement a number of functions including map pages or forms 22, map database 24, map analysis 26, results database 28, and report generator 29.

Briefly, the system 10 presents the user a display of the survey pages 15 via the web server 20 and browser 14. The survey pages 15 may make use of the map forms 22 to display survey questions. The user input to the survey pages is then stored in the map database 24, including a specification for how to store the responses as influence objects, as well as user perceptions as to the states of influence objects and their interrelationships with one another.

The user may then request the map analyzer 26 to process the influence objects and provide elements of the results database 28. The report generator uses the map database and results database to present the user with a display of the results of the map analyzer via the report/query pages 16.

The system provides the following specific functions:

1. Data Capture. The map forms 22 and survey pages 15 provide a data capture function which can capture, compile and analyze information continuously from a web based survey page file, but also any other practical source (informal discussion, mails, interviews, surveys, minutes of meetings, mission debriefing, forums, etc.). The compiled information is preferably stored in a data structure referred to as the influence objects.

2. Map Generation. The map database 24 and map analyzer 26 generate easy to use and understandable reports 16 that contain visual descriptions of situations, so that they can be discussed and shared between various organizational groups (sales, customer service, marketing, R&D, engineering, etc.).

3. Identify Issues. Resulting views provided by the report pages 16 allow users to identify potential issues and appropriate corrective actions, based on general rules, ad-hoc rules or related examples stored in a knowledge base.

4. Generate Summaries. The report 16 pages also provide executive summaries of organizational situations and project status to trigger and sustain strategic initiatives.

5. Measure Performance. Usage of the system 10 permits measuring key performance indicators, performing gap analysis and identifying practical opportunities for improvement.

6. Monitor Change. Usage of the system 10 permits monitoring the level of organization awareness and responsiveness from regular internal and external surveys as well as monitor key performance indicators,

Each of these functions and the data structures are described in greater detail below.

2. Data Structures

Data Dictionary: Definitions for the Spheres of Influence Objects

The system 10 contains data structures that represent human input on key determinants of organizational or enterprise change, represented by data objects called influence objects or “Spheres of Influence”. A first step in devising an appropriate organizational model is to develop a set of Spheres definitions that are appropriate to the enterprise. The labels and definitions for each Sphere are thus adapted to the use in the organization from a lexicon of the end user. One specific set of Spheres and lexicons that have been found to be useful in modeling the interaction among functions or departments in many organizations include eleven (11) such determinants as follows:

Culture=standards, Quality of Service, quality standards, values

Leadership=direction, management

Marketing=Marketing, communication, information, presentations, competition, market capability, market share

Strategy=Strategy, Planning, advising, milestones, feasibility studies, review

Finance=Finance, indicators, measures, performance levels, reports, costs, penalties, evaluation, risks, analysis, validation

Operations=Operations, performance, methodologies, processes, implementation, technology

Development=Development, R&D, training, design,

Sales=Sales, negotiating, buy-in, needs, expectations, account teams, pre-sales support, post-sales support, RFPs, offerings

Structure=agreements, contracts, commitments, services, policies, procedures, accountability, service requirements, infrastructure, data-warehouse

Staffing=Support, consultancy, service delivery, human resources

Customer=Customer, prospect, customer requirements

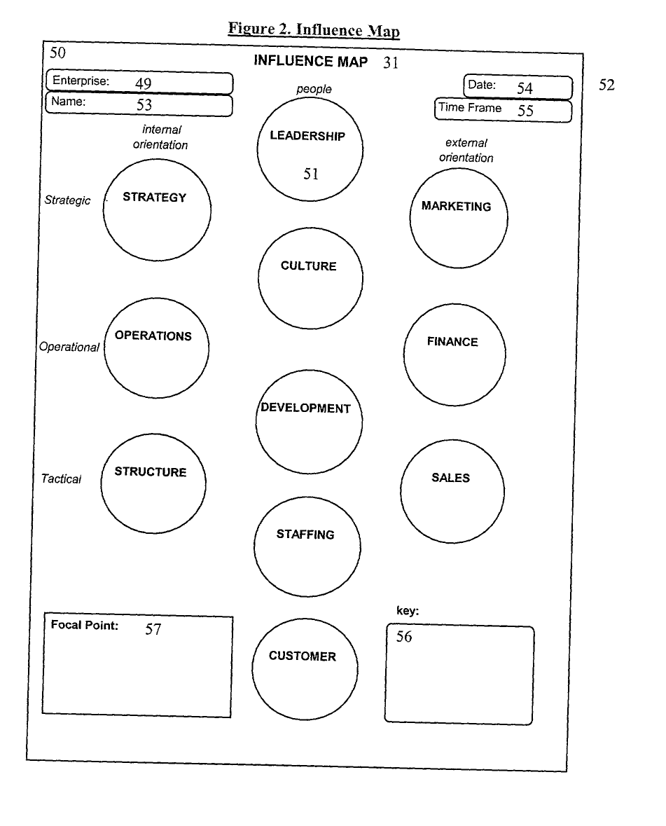

A graphical representation of one example of such a Spheres model is shown in FIG. 2. This representation is in the form of a so-called Influence Map 31. This arrangement of eleven Spheres 30 on the Influence Map 31 was empirically derived from the analysis of frequency of examples that illustrate the Spheres that are most likely to have influence on each other appear as Neighbors.

In a typical Spheres model representation a traffic signal paradigm is used to indicate survey responses. Thus, the surveys are preferably configured so that responses may be graphically coded as a Sphere 30 with a green, a yellow, or a red visual indicator. The green indicator is typically used to indicate a positive or “OK” response, yellow to indicate that the respondents feels this is an area that requires caution or further investigation, and red to indicate a problem or urgent concern.

As alluded to above, the spatial distribution of Spheres 30 in this manner can also be used to reveal relationships among the eleven Spheres, classified according to three “Neighborhoods”—Immediate, Extended, and Remote. The Neighborhoods represent relative distance between the Spheres 30.

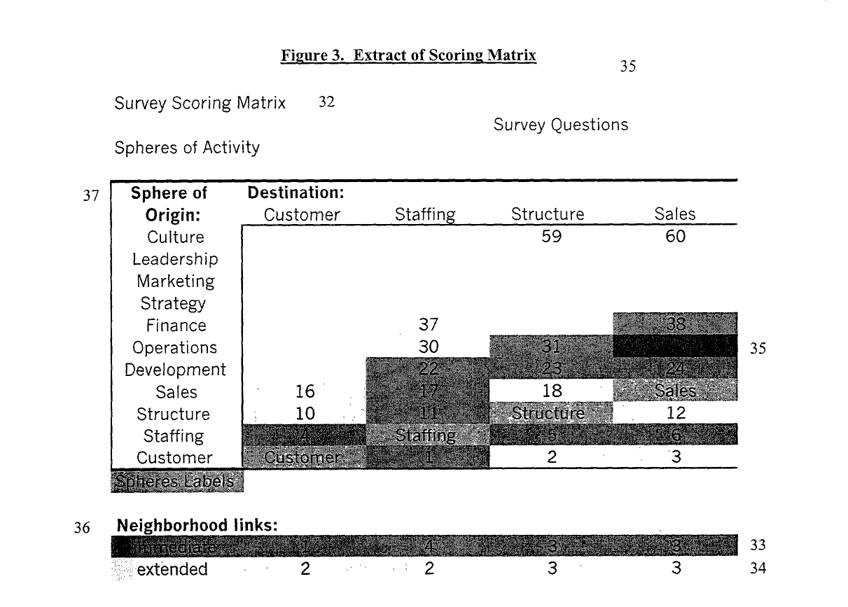

These spatial Neighborhood relationships are further defined using a Scoring Matrix for the overall Influence Map 31. For example, a chart or “Scoring Matrix” can be developed that shows the Neighborhood definitions for each Sphere in the illustrated 11×11 matrix. In one such Scoring Matrix 32, shown in FIG. 3, the Immediate Neighbors are coded as green 33, Extended Neighbors are coded as yellow 34, and Remote Neighbors are coded red 35. (Due to restrictions on the printing of color drawings by the Patent Office, the color yellow shows in the drawings as the lighter shaded areas, the color green as the next darker or middle shade of gray, and red as the next darker shade of gray and black in place of the color blue).

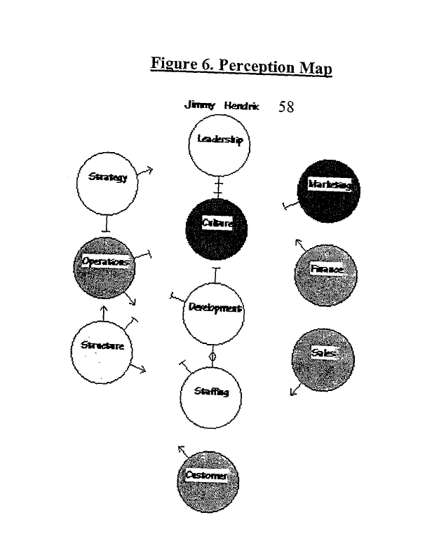

Virtually all survey responses in a large, complex organization appear as Immediate and Extended Neighbors. In the display (as shown on the attached maps in FIGS. 6-11) only the first two Neighborhood links 36 are typically populated with data. The Remote Neighbors will not typically be able to be populated without a special enabling function; this avoids unnecessary complication of the data object models. The restriction to populating Immediate and Extended Neighborhoods also prevents visualization problems using the Influence Maps, and populates the model with data instances that are relevant to the interaction of the closest neighbors.

The Neighborhood property of the Spheres object relates to various functions in the Map Analyzer 26. Neighborhood Analysis provides feedback on the structure of a questionnaire, on the complexity of an individual's reasoning and other attributes. The Scoring Matrix analysis can be included as one of the Reports as well.

Also note that the color of the cells in the Scoring Matrix32 are used to represent the Neighborhood to which the relationship as been assigned. For example, the Development/Staffing cell is coded “green” to indicate that these are Immediate Neighbors. However, the “Sales/Structure” cell is coded yellow, to indicate an Extended Neighbor relationship. The “Sales/Operations” cell is coded red, to indicate a Remote Neighbor relationship. Also note that the absence of a number in the cell indicates that the designer of the survey has provided no associated survey question for this cell.

The resulting 11×11 matrix37 generates up to 110 possible measurement points. However, in an 11 Sphere model, it is typically not the case that all possible combinations of Extended Neighbors are represented or needed in the Scoring Matrix.

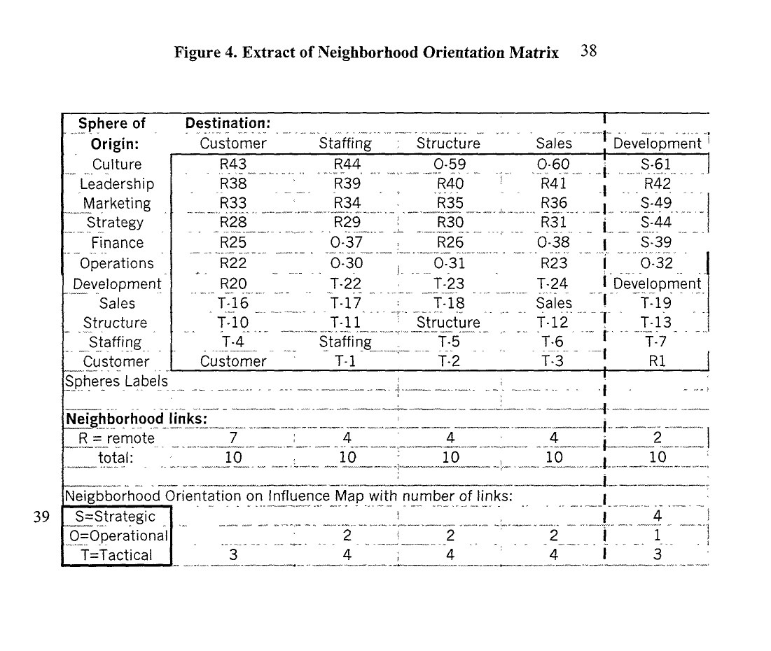

Further properties of the spatial array are revealed in a Neighborhood Matrix 38, shown in FIG. 4. The matrix is used to examine clusters of influence objects along the axis from top to bottom of the influence map in FIG. 2. “Strategic” activities tend to cluster toward the top of the map, operational in the middle and tactical toward the bottom 39.

Using this approach to modeling survey responses, robust measurement procedures can be used to get reliable data to analyze soft issues like customer satisfaction and awareness. Tools and procedures can also be specified to collect hard data such as financial metrics. The data collection procedures include design specifications for survey instrumentation shown in FIG. 540, data collection 41 and configuration of questions 42 pertaining to each influence object.

3. Knowledge Acquisition

One suggested set of criteria used to develop survey questions is now presented here in detail; it should be understood that other possible criteria can be used.

The primary rule of modeling for the survey designer is to remember that they are building the interviewee's model, not their own. This means that modelers must always be on guard against inserting their inferences into the questions or reading things into survey responses. Modelers should attempt to use the interviewee's actual words in the model and not the modeler's shorthand for what the respondent said.

The second aspect of devising an effective survey question in particular is to remember to look for the “big topic” that the organization is talking about in their illustration. Often it is easy to get overwhelmed by details. Mentally, modelers must be able to step back from the details and focus on the larger issues that are described by the details.

Big topic issues are indicated by key words that relate to the sets of activities contained in each Sphere. When listening to a client describing the events that prompted their color choice for a particular Sphere, the modeler is listening with that Sphere's neighbors in mind. Detecting the input of such data will then generate proper links between Spheres, whether they are a block or a connection.

There are pleasantly generic questions that a modeler can use to generate items to insert into the system by urging the interviewee to provide more data or clarity without leading the “witness”, so to speak, or putting words in their mouth.

Now let's consider some examples of questions and how they might be coded in the Scoring Matrix.

### EXAMPLE 1

During a set of questions in the area of Culture (i.e. in the Culture Sphere), one survey respondent (manager) made the comment “The Culture direction was communicated very well to the sales force through the documentation we used”.

In this first example, the client is in the Culture Sphere, so that is the Sphere of Origin for the link. The key words include references to data points and in this case include: “direction”, “communicated”, and “sales force.” The big topic, aside from the details of direction and communication, is the sales force “responding positively” to the corporate Culture. There are no indications that this was a marketing program, although a question to the client would have made that clear. So looking at what the client said, the score is a connection from Culture to Sales. If this had been a marketing push or a communications program, then the link might be different. Again, in populating the Scoring Matrix, the modeler stays with the actual text of what was said, avoiding reading into the response.

### EXAMPLE 2

In another instance, the topic was Staffing. The respondent reacted negatively, e.g., chose a blocked (red) response, to a statement, saying that, “We are hitting problems because everyone is so task-oriented that they are not taking the wider view” (and, by inference, not aligning with the vision/strategy).

In the second question, the Sphere of Origin is Staffing. The key words are “task oriented.” What are tasks, if not the way the enterprise gets its work done? Getting work done is the Operations Sphere. There are follow on implications of being task oriented, to be sure, as the client's inference implies with “that they are not taking the wider view” (and, by inference, not aligning with the vision/strategy). But in looking at the data and not what it might imply, survey questions pertaining to the link would be scored as a block from Staffing to Operations.

The survey database also allows responses to be analyzed by grouping respondents into six “Worlds of Work.” The classification and Naming of the organizational groups that are associated with each World mentioned in the text below must be verified for the accuracy and completeness of their respective World classification:

Enterprise: entire company

Executives: Senior Executives, Office of the Chairman

Virtual Teams: Vice President functions, cross-geographical projects, cross-functional teams

Work Systems: managers with resource allocation decision authority, regions, engineering units, operational units, help desks; service delivery; operations; finance; legal department; marketing; customer service units

Work Groups: account teams, work groups, project teams, technical consultancy teams, customer support

Individuals: grouped by role, responsibility, demographics, consultants, technical staff; support staff; administrative assistants; customers.

4. Survey Self Scoring

After the user selects a Traffic Signal color 43 for a given Sphere of activity 41, and/or a color to represent their forecast of another user or group 44, a pick list menu 42 appears. The list shows the closest Spheres first (<<immediate Neighbors>>) followed by those further away on the Map (<<Extended Neighbors>>). The order of Spheres on the list will vary, with the Spheres in each Neighborhood ordered according to a master sequence.

After making the Traffic Signal color choice, an instruction appears asking the person to “Answer Yes or No” 45 to a list of pre-defined questions 42. The system administrator can configure the, “Examples Pick List” menu according to several options. The Examples Pick List menu could show Survey items, and/or historical examples from a previous data set stored as an Enterprise Model, and/or allow the person to modify their previous responses, and/or update the last Survey that the person completed.

The “title bars” (labels) of the pick list menu window identifies the type of survey configuration 41.

At the end of the Examples Pick List menu, the user may invoke an option to add their own new example in a text box attached to each link, for exampl;e, by clicking on its number code 46. With this option, the person enters their illustration in a text box 47. The pre-configured examples and the new examples are thus scored automatically.

An alternative way to code link information is presented in ASCII text symbols.

| Symbol | type | in one word | in three words | natural language text |
|---|---|---|---|---|
| “+” = | Connection | accomplishment | met and mastered | “We have. . .” |
| “−” = | Block | barrier | met, not mastered | “We have not. . .” |
| “. . .” = | Opportunity | suggestion | a practical idea | “We should. . .” |

After choosing the pre-configured example, or entering a new text example, the user clicks on an “OK” button 48 at the bottom of the screen for the system to accept the input. The system then prompts the person to ask whether they have additional examples for the same relationship.

“There may be positive and negative examples for the same Spheres. A write-in item will allow additional comments, with a prompt such as, <<Do you have anything to add about the relationship between [Sphere of Origin] and [Destination Sphere]?>>

The person may offer additional examples for the same two neighboring Spheres, creating different types of links (Connections, Blocks, Opportunities) for the same Neighbors.

5. Knowledge Representation Methods

Description of Data Structures for Maps that are used as System Outputs

This section sets forth the functionalities that specify user interface procedures and underlying rules of a generalized system to measure organizational change. To accomplish this, operational definitions are, made testable and able to be validated by the concerned parties for the following terms:

organization—defined by specifying labels for eleven key determinants or “spheres” of whole systems change, that may be defined as an ‘enterprise 49 shown in FIG. 2”;

perception—defined by an operation to designate, collect, quantify and compile qualitative and quantitative data (subjective judgments and supporting facts) in differentiated states, that may be rendered with the use of a “Traffic Signal code” as a proportion of color within a sphere;

dynamics—defined by quantifying the state of relationships between various activities or events to specify the rate, level and direction of interactivity between them, that may be called “links”;

view—as defined by a stratified levels of responsibility which cluster data according to working units, or social groups, that may be called “worlds”;

value—specified (in the discipline of systems dynamics) as a virtuous cycle of exchanges of energy (resources over time) among three activities, that may be called “triangulation”;

process—specified as a system that has definable inputs; methods; mechanisms; procedures; controls and outputs, comprising a six step business process model, that may be called a “six step process”:

The interactive, adaptive design of the architecture is enabled through the use of Maps that are not only used to represent and input perceptions, but also to display output of the data analyzer 26. The Maps may include embedded links to an online agent that functions as an intelligent Guide (agent functions). Users have the ability to modify various items to provide interpretive guidance, or generate new or updated input for the system. Users can validate and test the accuracy of their perceptions and the validity of this so-called “factual” data. Maps comparing the interaction of two data sets (perceptions and facts) can also be used to measure the change process.

6. Output Data Structure

In a preferred embodiment, the Maps use the underlying display and positioning of 11 Spheres, as shown already in FIG. 2, as a general layout. This layout is called the “Influence Map.” The configuration of the Influence Map is used as the user interface infrastructure.

The visual layout of the Maps may be specified as a style sheet in XML, in which data are encoded and placed in various positions on the Map via the respective objects on the map.

In the object oriented specification, a Map Page 50 object is the underlying visualization object to which all the other objects are attached. The Map Page object is also called a “World.” The border around the Map Page designates the World that the user is viewing, and/or is a member.

Additional objects, which may cross reference to other objects, attached to the Map page include eleven Spheres Array objects 51. The Spheres Array objects, in the preferred embodiment, include eleven Spheres data objects (i.e., the influence objects). The Spheres may be defined with variable size, variable labels, and variable colors. Spheres are named, coded and reported in sequence from highest to lowest code number.

In the preferred embodiment, each Influence Map object contains 11 such Spheres objects, with each Sphere corresponding to one of the areas of organizational activity as follows:

11. Culture

10. Leadership

9. Marketing

8. Strategy

7. Finance

6. Operations

5. Development

4. Sales

3. Structure

2. Staffing

1. Customer

The order of Spheres is maintained through the different Map types, as will be understood shortly. It is possible to use other labels for describing the function of the Spheres in other embodiments.

The Map objects may contain other elements. The preferred embodiment includes:

Rounded corner text box objects—for Map identification 52

Enterprise—contains an identification of the organization, to appear in the upper left-hand corner of the page 49

Name—name of respondent or the World 53

Date—the present date 54

Time Frame—period under analysis 55.

The Map may also include a Map legend or Dynamic key object 56, with variable text and icon elements that correspond to the information on the respective Map being viewed. The keys may include a variable text or graphic legend. The keys on the six different display maps use different combinations of interactive icons that control various viewing functions for the particular Map from a control panel. Icon functions may also appear in the “key” on each map.

An “Activity level” indicator displays at least three lines with lowest (lo), medium (med), and highest (hi) thickness appearing on the respective Map and the number of links associated with the varying thickness. This format uses proportional thickness to overcome a visualization problem of having some links that appear so thick that they mask other data or make the Map difficult to read.

A Focal Point object may appear as a text box with square corners 57. The label “Focal Point” appears in the upper left-hand corner of the text box. The Focal Point object allows a natural language SQL type query into the database to populate a given map based on a user defined or predefined question.

The layout specification of an Influence Map object includes typically the following data:

Influence Map

| Title | Perception Map |
|---|---|
| Enterprise | Name of the Enterprise (varchar 30) |
| Focal Point | Name of the Focal Point (varchar 50) |
| Individual's | Last name of the person interviewed (varchar 50) |
| Family name | |
| Individual | First Name of the person interviewed (varchar 50) |
| First name | |
| Date | Dd/mm/yyyy |
| Sphere | Matrix with 2 columns and 11 lines listing the name of |
| names | each Sphere: |
| | Column 1 is the number of the Sphere (integer ordered |
| | from 11 to 1) |
| | Column 2 is the name of the Sphere (varchar 30) |
| Sphere | Matrix with 2 columns and 11 lines listing the color of |
| colors | each Sphere: |
| | Column 1 is the number of the Sphere (integer ordered from |
| | 11 to 1) |
| | Column 2 is the code of the color of the Sphere (green, |
| | yellow, red, |
| | blue or empty which means no color - i.e. transparent) |

The graphical specification, which is tied to the object data representation, includes a specification for how to render the Influence Map graphically in a Report. Such a specification may include information specifying how to render

the name of the Enterprise, e.g., in a box with rounded corners on the top left in black 49;

the name of the individual respondent or group of persons involved (called a “World”), e.g., appearing under the Enterprise box in black 53;

the objective of the inquiry, called the “Focal Point”, e.g., in a box with squared corners on the bottom left in black 57;

a date at the top right hand corner, e.g., opposite the Enterprise box, inside a box with rounded corners 54;

a time frame related to the inquiry, under the date box, e.g. opposite the name box, inside a box with rounded corners 55;

the name of the Map, e.g., at the top center of the page in black 3

a Map Page display object bordering the Map, e.g., preferable displayed with squared corners with an optional “shadow” effect 50;

the border color specification, e.g., data that correspond to a variable color code that is assigned to the World View (the default color is black 50); and

the eleven Sphere objects, e.g., render as circles in the associated Sphere position on the Map page 51.

The name attribute of the each Influence Map object also affords a way to implement access restrictions. This provides an important function, such as being able to guarantee that an individual's response data remains confidential. Access is restricted to the Individual respondent. A preferred implementation also allows the individual respondent to “publish” or make public their results, with the option to share Traffic Signal colors, links, survey or text responses. This is necessary to account for situations where the individual gets a promotion to an executive position, holds a temporary leadership assignment as head of a project or team, or career counseling.

An immediate case applies where an Individual is a member of the “Executive” World. In this case, the person is typically in charge of, and thus also a Member of, a Work System World. In this case, the Executive's Traffic Signal color responses are visible to the other Members of the Work System World (their direct reports) of which the Executive is in charge. If the Executive is the CEO or head of the “Enterprise” and/or the Sponsor of the Focal Point question and definition of the Enterprise, the Traffic Signal colors are visible to all Enterprise Members.

8. The Six Display Maps Used for Compiled Reports

Turning attention now to FIGS. 6 through 11, there are illustrated a number of different Display or Report Maps that can be devised from analyzing one or more of the data sets generated as part of survey process. The different visual renderings of the six Report Maps vary based upon the way in which the Spheres are colored and the types of links between them. In general, these include:

(1) Perception Map (FIG. 6)—displays a scored and compiled input of an individual person/respondent 58.

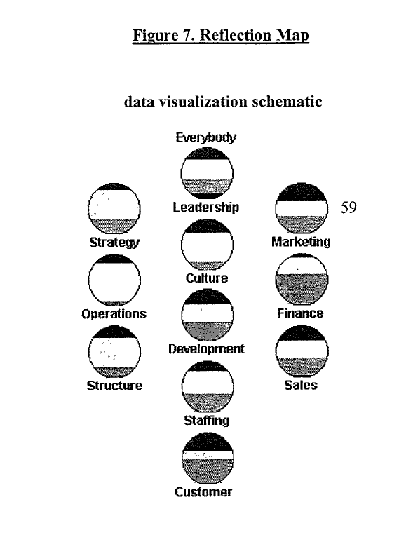

(2) Reflection Map (FIG. 7)—shows compiled Traffic Signal (color) datarepresented proportionally for each color and shown inside each sphere 59 for Worlds or other combinations of Influence Maps.

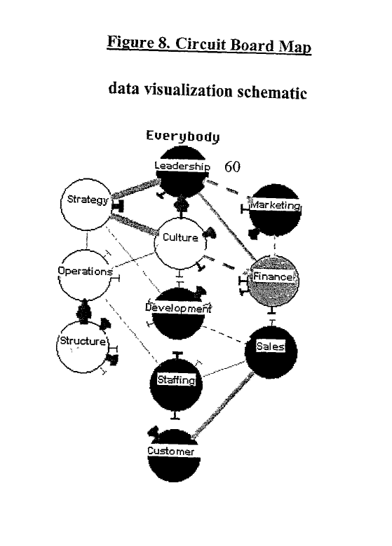

(3) Circuit Board Map (FIG. 8)—shows compiled links for a World Represented as different types of lines 60.

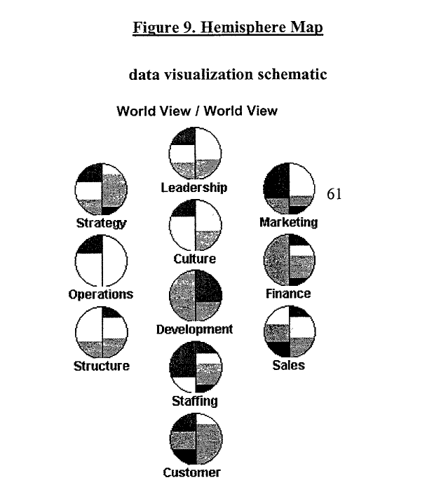

(4) Hemisphere Map (FIG. 9)—shows a comparison of two World Views with data compiled inside of the same sphere 61.

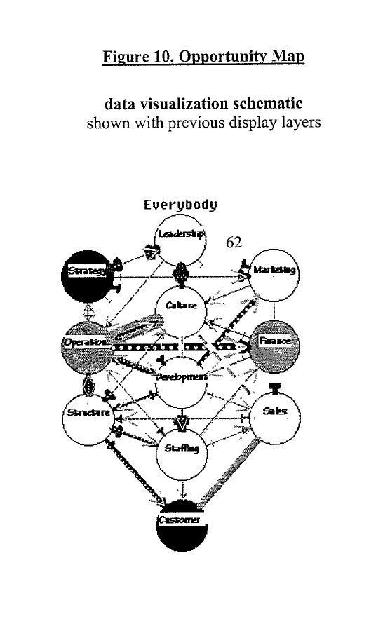

(5) Opportunity Map (FIG. 10)—shows the places where a Connection can be created, following rules that build triangulations among three Spheres 62.

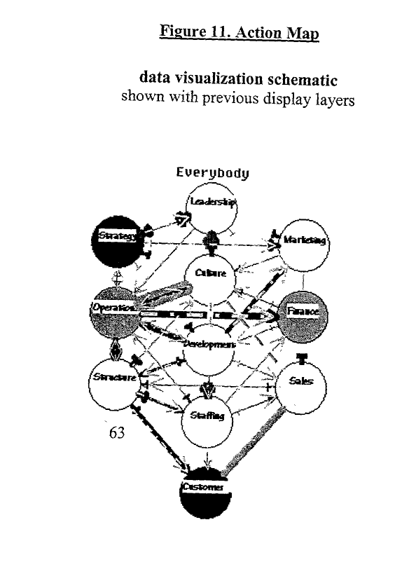

(6) Action Map (FIG. 11)—shows the opportunities that have been selected for action as dash-dot-dashed lines 63.

Perception Map

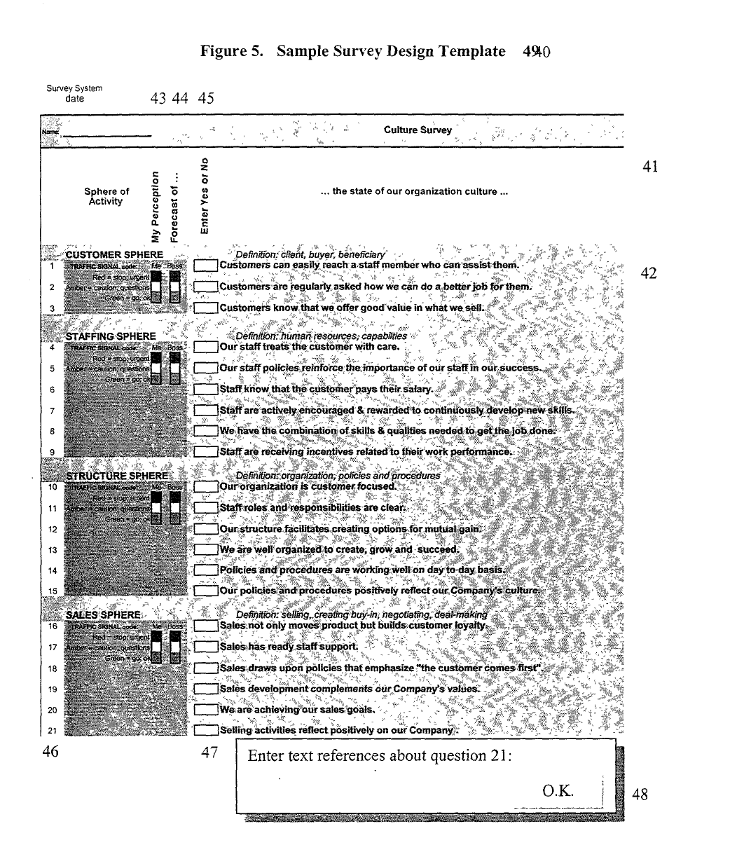

Turning attention now more particularly to FIG. 5, the Perception Map is a visual representation of a particular person's response to survey questions. Recall that the color of a Sphere may be red, yellow, or green. The color blue is also used to indicate certain other responses such as “don't know” or “empty”.

The links illustrated in the Perception Map can be of several types. These include an Individual positive link (“Connection”), which is graphically displayed as a black arrow, as shown. An Individual negative link (“Block”) is graphically illustrated as a black “hammer” in the Perception Map.

Although not shown in the example of FIG. 5, another type of link, known as an “Opportunity link” can be made part of the Perception Map. The Opportunity type link is graphically indicated as violet dotted lines, with an option to show directionality with an arrowhead, connecting two Spheres. In cases where there is more than one Opportunity link between two Spheres, the respective lines will vary in thickness.

Links may also have various properties attached, including: text, color, pointers to other maps, locations, or databases, a time clock, counters, the name of a World or person, thickness, an arrowhead (pointed arrow or flat hammerhead), SQL queries, etc.

A Perception Map has attributes similar to those in its corresponding Influence Map, such as a Title, Enterprise, Focal Point, Individual's Name, and Date information, as well as additional attributes such as at least a specification for sphere colors and Links.

A specification for a Perception Map object as stored in the database is as follows:

Perception Map

| Title | Perception Map |
|---|---|
| Enterprise | Name of the Enterprise (varchar 30) |
| Focal Point | Name of the Focal Point (varchar 50) |
| Person's | Last name of the person surveyed (varchar 50) |
| Family name | |
| Person's | First Name of the person surveyed (varchar 50) |
| First name | |
| Date | Dd/mm/yyyy |
| Sphere | Matrix with 2 columns and 11 lines listing the |
| names | name of each Sphere: |
| | Column 1 is the number of the Sphere (integer ordered |
| | from 11 to 1) |
| | Column 2 is the name of the Sphere (varchar 30) |
| Sphere | Matrix with 2 columns and 11 lines listing the color |
| colors | of each Sphere: |
| | Column 1 is the number of the Sphere (integer ordered from |
| | 11 to 1) |
| | Column 2 is the code of the color of the Sphere |
| | (green, yellow, red, |
| | blue or empty which means no color - i.e. transparent) |
| Sphere links | Matrix with 5 columns and a maximum of 110 lines |
| | containing the links between each pair of Spheres: |
| | Column 1 is the number of the Sphere of Origin (integer |
| | ordered from 11 to 1) |
| | Column 2 is the number of the Destination Sphere |
| | Column 3 is the number of positive links between |
| | Sphere of Origin and the Destination Sphere |
| | Column 4 is the number of negative links (i.e. Block) |
| | between Sphere of Origin and the Destination Sphere |
| | Column 5 is the number of Opportunities between |
| | the Sphere of Origin and the Destination Sphere |

Reflection Map

A graphical rendering of a Reflection Map is shown in FIG. 6. The Reflection Map is used to illustrate compiled Traffic Signal (color) data for a group of related Influence Maps. The Reflection Map is generated by determining statistics from the group, such as may be contained in a particular World. In the graphic depiction of a Reflection Map, the circles representing each Sphere are colored in a range of different colors, depending upon the particular aggregate statistics. For example, in the Structure Sphere in the FIG. 6 example, the compiled responses were approximately 15% green (the bottom colored portion of the Sphere), 60% yellow (indicated by the central yellow portion) and 25% red (indicated by the upper portion). The Sales Sphere statistics for this World indicated 3% blue (or unanswered), 24% green.

A Reflection Map object may take a form as follows:

Reflection Map

| Title | Reflection Map |
|---|---|
| Enterprise | Name of the Enterprise (varchar 30) |
| Focal point | Name of the Focal Point (varchar 50) |
| World | Name of the World (varchar 30) |
| Date | Dd/mm/yyyy |
| Sphere names | Matrix with 2 columns and 11 lines listing the name |
| | of each Sphere: |
| | Column 1 is the number of the Sphere (integer ordered |
| | from 11 to 1) |
| | Column 2 is the name of the Sphere (varchar 30) |
| Sphere colors | Matrix with 5 columns and 11 lines listing the color of |
| | each Sphere: |
| | Column 1 is the number of the Sphere (integer ordered |
| | from 11 to 1) |
| | Column 2 is the % of green in the Sphere |
| | Column 3 is the % of yellow in the Sphere |
| | Column 4 is the % of red in the Sphere |
| | Column 5 is the % of blue in the Sphere |

Circuit Board Map

Circuit Board Maps are used to illustrate different compiled links for a particular World. An example rendering of a Circuit Board Map is shown in FIG. 7. A Circuit Board Map is principally used to represent Complied Connections (green connecting lines), Compiled Blocks (as red lines [Blocks]) or Cancellations (equal number of connections and blocks, shown as dashed blue lines).

For example, a compiled Connection may rendered as a green line with varying thickness, including an option to make an arrowhead visible to show directionality of the link. The thickness of the green line indicates how many of the underlying Influence Maps indicated a Connection. A proportional thickness sizing function may be used to represent a large number of instances.

Similarly, a compiled Block may be indicated as a red “hammer”, with a varying thickness.

A Cancellation may be indicated on the Circuit Board Map as a blue dashed line with varying thickness (the Circuit Board Map of FIG. 7 uses a solid lines to illustrate a Cancellation between the Leadership Sphere and the Marketing Sphere and does not show in the dash format). The Cancellation may include an option to make the arrowhead visible to show directionality.

A number of rules can be devised that control the generation of a visual representation of a Circuit Board Map object by the analyzer 26. For example,

Given Pab=the total number of positive links between Sphere A and Sphere B,

Given Pba=the total number of positive links between Sphere B and Sphere A,

Given Nab=the total number of negative links from Sphere A to Sphere B, and

Given Nba=the total number of negative links from Sphere B to Sphere A, then

1.) If Pab+Pba>Nab+Nba then the compiled link between A and B is a green line (Connection) whose thickness=(Pab+Pba)−(Nab+Nba).

2.) If Pab+Pba=Nab+Nba then the compiled link between A and B is a blue line (Cancellation) whose thickness=(Pab+Pba)+(Nab+Nba).

3.) If Pab+Pba<Nab+Nba then the compiled links result in one of the next three possibilities:

3.1.) If Nab>Pab and Nba>Pba then there is a negative link [red Block] from A to B whose thickness=Nab−Pab AND a negative link (red Block) from B to A whose thickness=Nba−Pba

3.2) If Nab>Pab and Nba<=Pba then there is only one negative link [red Block] from A to B whose thickness=(Nab+Nba)'(Pab+Pba)

3.3.) If Nab<=Pab and Nba>Pba then there is only one negative link [red Block] from B to A whose thickness=(Nab+Nba)−(Pab+Pba)

4.) Finally, if the compiled links among three Spheres are all green lines, then the combination forms a triangle that is coded and labeled as a Knowledge Asset (Ka).

Below is a detailed list of the elements of a Circuit Board Map object.

Circuit Board Map

| Title | Circuit Board Map |
|---|---|
| Enterprise | Name of the Enterprise (varchar 30) |
| Focal point | Name of the Focal Point (varchar 50) |
| World | Name of the World (varchar 30) |
| Date | Dd/mm/yyyy |
| Sphere | Matrix with 2 columns and 11 lines listing the name |
| names | of each Sphere: |
| | Column 1 is the number of the Sphere (integer ordered |
| | from 11 to 1) |
| | Column 2 is the name of the Sphere (varchar 30) |
| Sphere | Matrix with 2 columns and 11 lines listing the |
| colors | 7 color of each Sphere: |
| | Column 1 is the number of the Sphere (integer ordered |
| | from 11 to 1) |
| | Column 2 is the code of the color of the Sphere |
| | (green, yellow, red, |
| | blue or empty which means no color - i.e. transparent) |
| Sphere | Matrix with 6 columns and a maximum of 110 lines |
| links | containing the links between each pair of Spheres: |
| | Column 1 is the number of the Sphere of Origin (integer |
| | ordered from 11 to 1) |
| | Column 2 is the number of the Destination Sphere |
| | Column 3 is the number of positive (i.e. Connection) |
| | links between |
| | Sphere of Origin and Destination Sphere |
| | Column 4 is the number of negative links |
| | (i.e. Block) between Sphere |
| | of Origin and the Destination Sphere |
| | Column 5 is the number of positive and negative |
| | link combinations (i.e. Cancellations) between the |
| | Sphere of Origin and the Destination Sphere |
| | Column 6 is the number of triangles that are formed |
| | by Connections (green lines) linking three |
| | Spheres. These triangles are called |
| | “Knowledge Assets.” The Knowledge Assets |
| | appear as solid green lines among three Spheres. |

Hemisphere Map

Hemisphere Maps are a technique for displaying compilations of two sets of perception data in one Map. In the visual representation, the text boxes showing the date, Enterprise, World Name, Focal Point, Time Frame are “doubled up” to indicate the data elements from each set. The preferred format shows text separated by a forward slash mark, showing both variables side by side (e.g. Enterprise A/Enterprise B.) Only the variables that relate to the variables under comparison appear on the screen. For example, if the comparison is for the same Enterprise with the same Focal Point on two different dates, only the date box will show the doubled text. Variable boxes that are relevant to the comparison shown on the Hemisphere Map are highlighted/outlined in blue and the text changes from black to blue.

The colors of the Spheres in a Hemisphere Map are typically some sort of mix of the colors that would be rendered in each of the two corresponding Reflection Maps. For example, as shown in FIG. 8, a Hemisphere Map displays each Sphere with a dividing line. Each half of the Sphere, one on the left, one on the right is then rendered in the colors that would be rendered for the corresponding Sphere in a Reflection Map.

A data object for representing a Hemisphere Map is as follows:

Hemisphere Map

| Title | Hemisphere Map |
|---|---|
| Sphere names | Hemisphere Maps display only one set of names |
| | (otherwise the Map would not be readable). |
| | This is why as opposed to Enterprise, Focal |
| | Point, World and Date, there is only one set of Sphere |
| | names. |
| | Matrix with 2 columns and 11 lines listing the name of |
| | each Sphere: |
| | Column 1 is the number of the Sphere (integer ordered |
| | from 11 to 1) |
| | Column 2 is the name of the Sphere (varchar 30) |
| Enterprise | Name of the Enterprise of the left Hemisphere |
| left | (varchar 30) |
| Focal Point | Name of the Focal Point of the left Hemisphere |
| left | (varchar 50) |
| World left | Name of the World of the left Hemisphere (varchar 30) |
| Date left | Date displayed for the left Hemisphere Dd/mm/yyyy |
| Sphere colors | Matrix with 5 columns and 11 lines listing the color |
| left | of each Sphere on the left Hemisphere: |
| | Column 1 is the number of the Sphere (integer ordered |
| | from 11 to 1) |
| | Column 2 is the % of green in the Sphere |
| | Column 3 is the % of yellow in the Sphere |
| | Column 4 is the % of red in the Sphere |
| | Column 5 is the % of blue in the Sphere |
| Enterprise | Name of the Enterprise of the right Hemisphere |
| right | (varchar 30) |
| Focal Point | Name of the Focal Point of the right Hemisphere |
| right | (varchar 50) |
| World right | Name of the World of the right Hemisphere (varchar 30) |
| Date right | Date displayed for the right Hemisphere Dd/mm/yyyy |
| Sphere colors | Matrix with 5 columns and 11 lines listing the color of |
| right | each Sphere on the right Hemisphere: |
| | Column 1 is the number of the Sphere (integer ordered |
| | from 11 to 1) |
| | Column 2 is the % of green in the Sphere |
| | Column 3 is the % of yellow in the Sphere |
| | Column 4 is the % of red in the Sphere |
| | Column 5 is the % of blue in the Sphere |

Note: The “Left” and “Right” designations for text data refer to the left and right hand side of the respective text box. The text strings appear next to each other in the respective text box separated by a forward slash (/)—not on different sides of the Map.

Opportunity Map

An Opportunity Map as illustrated in FIG. 9 is useful for showing Opportunities that have been selected to have resources assigned—including an Initiator—e.g., the person responsible for overseeing or taking the Action, milestones, timetable, budget, etc.

An Opportunity may be rendered as a violet dotted line with an arrow with varying thickness similar to the solid lines as shown in FIG. 9 (which does not show the dotted format). For example, an Opportunity exists between Operations and Finance. An Action link may also be represented as a violet line comprised of alternating dots and dashes, with an optional arrowhead, and with varying thickness, as shown, to indicate its relative importance.

Although not shown separately in the example of FIG. 5, another type of link, known as an “Opportunity Triangle: is graphically indicated as a combination of Opportunity links among three Spheres where three dotted violet lines, with an option to show directionality with an arrowhead, or the addition of one or two violet dotted lines to Spheres whose neighbors already have solid links (connections) already in place, creates a triangle among three Spheres. In cases where there is more than one Opportunity link between any of the three Spheres, the respective lines will vary in thickness.

An Opportunity Map data object is shown below:

Opportunity Map

| Title | Opportunity Map |
|---|---|
| Enterprise | Name of the Enterprise (varchar 30) |
| Focal Point | Name of the Focal Point (varchar 50) |
| World | Name of the World (varchar 30) |
| Date | Dd/mm/yyyy |
| Sphere | Matrix with 2 columns and 11 lines listing the |
| names | name of each Sphere: |
| | Column 1 is the number of the Sphere (integer ordered |
| | from 11 to 1) |
| | Column 2 is the name of the Sphere (varchar 30) |
| Sphere | Matrix with 2 columns and 11 lines listing the |
| colors | color of each Sphere: |
| | Column 1 is the number of the Sphere (integer ordered |
| | from 11 to 1) |
| | Column 2 is the code of the color of the Sphere |
| | (green, yellow, red, |
| | blue or empty which means no color - i.e. transparent) |
| Sphere | Matrix with 6-8 columns and a maximum of 110 lines |
| links | containing the links between each pair of Spheres: |
| | Column 1 is the number of the Sphere of Origin |
| | (integer ordered from 11 to 1) |
| | Column 2 is the number of the Destination Sphere |
| | Column 3 is the number of positive links between |
| | Sphere of Origin and the Destination Sphere |
| | Column 4 is the number of negative links (i.e. Block) |
| | between Sphere of Origin and the Destination Sphere |
| | Column 5 is the number of positive and negative |
| | link combinations (i.e. Cancellations) between the |
| | Sphere of Origin and the Destination Sphere. |
| | Column 6 is the number of Opportunities (violet |
| | dotted lines with arrows) between Sphere |
| | of Origin and the Destination Sphere. |
| | Column 7 is the number of Opportunity Triangles |
| | formed by a given Opportunity link. |
| | The Opportunity Triangles appear as violet dotted |
| | lines with or without arrows among three Spheres. |
| | Connections may exist between one or two of the |
| | three Spheres. Where Connections |
| | already exist, the dotted violet line |
| | overlaps with the solid green line. |
| | The Analyzer prioritizes and sequences Opportunity |
| | Triangles according to the color of the Spheres, |
| | the number and type of links that are already in |
| | place, the World in which the Action will take |
| | place, the number of triangulations the Opportunity |
| | will create. Once an Opportunity is selected, |
| | it is considered as a link that can be used as |
| | part of a new Opportunity Triangle. |
| | Note: The Actions between Sphere of Origin and |
| | the Destination Spheres that have been selected |
| | as actionable appear on the Action Map that |
| | follows. “Actionable” means that one |
| | or more of the Members can initiate an Action |
| | that will accomplish something with |
| | resources available. This person is called |
| | the Action Initiator. |
| | Column 8 is the name of one or more Worlds |
| | that can be called upon to nominate an Action |
| | Initiator for a given Opportunity link. This is |
| | based on the analysis of Maps from the set of |
| | Worlds included in the model database. Nominations |
| | may include the World related to the |
| | Opportunity Map, or a different World. |

An Opportunity Map is the addition of violet dotted lines with arrows to a Circuit Board Map. The thickness of these arrows depends upon the number of Opportunities between two Spheres.

Other than that, green, red, blue lines are compiled exactly like the Circuit Board Map. The three types of Maps (Circuit Board, Opportunity and Action) can be displayed by the same function with appropriate arguments. We would call the same function with columns 3 4 and 5 empty to display an Opportunity Map without green, red, blue lines or vice versa.

The same principle applies to an Action Map object that follows.

Action Map

The Action Map is a complement to the Individual Map. It provides an output that the individual responsible for taking action uses to guide and track progress, and report results. Once an Action is completed, the Action Initiator cycles the completed task back into the system as input for an updated model.

Action Map

| Title | Action Map |
|---|---|
| Enterprise | Name of the Enterprise (varchar 30) |
| Focal | Name of the Focal Point (varchar 50) |
| Point | |
| World | Name of the World (varchar 30) |
| Date | Dd/mm/yyyy |
| Sphere | Matrix with 2 columns and 11 lines listing the name |
| names | of each Sphere: |
| | Column 1 is the number of the Sphere (integer ordered |
| | from 11 to 1) |
| | Column 2 is the name of the Sphere (varchar 30) |
| Sphere | Matrix with 2 columns and 11 lines listing the color |
| colors | of each Sphere: |
| | Column 1 is the number of the Sphere (integer ordered |
| | from 11 to 1) |
| | Column 2 is the code of the color of the Sphere |
| | (green, yellow, red, |
| | blue or empty which means no color - i.e. transparent) |
| Sphere | Matrix with 7 columns and a maximum of 110 lines |
| links | containing the links between each pair of Spheres. |
| | Column 1 is the number of the Sphere of Origin |
| | (integer ordered from 11 to 1) |
| | Column 2 is the number of the Destination Sphere |
| | Column 3 is the number of positive links (i.e. Connections) |
| | between Sphere of Origin and the Destination Sphere |
| | Column 4 is the number of negative links (i.e. Blocks) |
| | between Sphere of Origin and the Destination Sphere. |
| | Column 5 is the number of positive and negative link |
| | combinations (i.e. Cancellations) between the |
| | Sphere of Origin and the Destination Sphere. |
| | Column 6 is the number of Action links (violet solid line |
| | with an arrow) between Sphere of Origin and |
| | the Destination Sphere. |
| | Column 7 is the number of Knowledge Assets (Ka) formed |
| | by a given Action link. The Knowledge Assets |
| | appear as solid green lines with or without |
| | arrows among three Spheres. Connections may |
| | already exist between one or two of the three |
| | Spheres. Where Connections already |
| | exist, the green Knowledge Asset line overlaps |
| | with the green Connection line. The Analyzer prioritizes |
| | and sequences Knowledge Assets according to the color of |
| | the Spheres, the number and type of |
| | links that are already in place, the |
| | World in which the Action will take |
| | place, the number of Knowledge Assets |
| | the Action will create. Once |
| | an Action is completed, it is considered |
| | as a link that can be used as |
| | part of a new Knowledge Asset. |
| | Note: The Actions between Sphere of Origin |
| | and the Destination |
| | Spheres that have been selected as actionable. |
| | “Actionable” means that |
| | one or more of the Members can initiate an Action that will |
| | accomplish something with the resources |
| | available. This person is |
| | called the Action Initiator. |
| | Column 7 is the name of the Action Initiator, |
| | the person who has |
| | signed up to be responsible for taking the Action. |

While this invention has been particularly shown and described with references to preferred embodiments thereof, it will be understood by those skilled in the art that various changes in form and details may be made therein without departing from the scope of the invention encompassed by the appended claims.

What is claimed is:

1. A process implemented in a network of client browser and application server computers for interactive, collaborative group decision making among multiple participants, the process comprising the steps of:
specifying elements of a participant survey process, the survey elements each relating to one or more spheres of influence objects to be used in a decision making process;
collecting survey response data for the survey elements from multiple participants using a survey process;
specifying an automatic logic model process for facilitating group decisions according to decision logic functions given the survey response data as inputs;
automatically and continuously analyzing the survey response data to provide a compiled collaborative group decision, reflecting changes to the survey response data on a real time basis;
automatically and continuously identifying, collecting and compiling opportunities for action to improve organizational performance; and
automatically tracking changes and monitoring performance to provide guidance in managing the change process.

2. A process as in claim 1 additionally comprising the step of:
presenting a real time interactive display of results of the analyzing step.

3. A process as in claim 1 wherein the survey response data is categorized by participant class.

4. A process as in claim 3 where in step (e) provides the consolidated results display to participants, and individual participants are not permitted to review survey results for other individual participants without their consent.

5. A process as in claim 1 wherein the group decision making process is a framework for organizational decision making.

6. A process as in claim 1 wherein the spheres of influence elements are selected from a group consisting of leadership, marketing, strategy, finance, operations, sales, structure, culture, development, staffing, and customer elements and populated with data from a questionnaire.

7. A dynamic multidimensional array for the purpose of representing information pertaining to the measurement of human reasoning when confronted with whole systems change wherein determinants of change are represented as influence objects;
wherein the determinants are arranged in a logical spatial display with respect to one another; and
wherein the pattern of the determinants is statistically derived from frequency distribution of the interactions reported among the determinants through a procedure for classifying categorizing and scoring data.

8. An array as in claim 7 wherein the configuration of sphere objects is displayed as circles

9. An array as in claim 8 wherein the sphere objects are populated via a distributed data network system input interface.

10. An array as in claim 8 wherein higher order relationships between the spheres are represented in a spatial array.

11. An apparatus to collect and display human perceptions in the context of a real time dynamic model of a network of event nodes comprising:
a data object having several functions enabled by the same icon, including an input and a state representing data that incorporates a trigger mechanism, a link pointing to other object, a control switch to enable various functions shown on the array of influence objects, and an output message that is visualized as it is being passed to the database objects to encode data to indicate a state of change of an influence object. activity.

12. An apparatus as in claim 11 wherein the mechanism encodes three possible states of change of the activity.

13. An apparatus as in claim 12 wherein a graphical rendering of the switching mechanism is a representation of a traffic light as red yellow and green lights.

14. An apparatus as in claim 11 wherein the data object represents a direction of change towards a desired or undesired state.

15. An apparatus as in claim 11 wherein the data object enables a perception of that state of change prior to potentially catastrophic events or advantageous opportunities (prompting adaptive rather than reactive behavior).

16. A graphic display object for showing proportional distribution of responses in a survey data structure,
displayed as a circle with proportional display of red, yellow, green and blue colors alone or in any combination, typically ordered so that red appears at the top of the circle, followed by yellow, green and blue at the bottom of the circle.

17. The graphic display object as in claim 16 wherein the object is used to report the distribution of data which has been color-coded or shaded according to differentiated patterns.

18. The graphic display object of claim 16 wherein the object further comprises:
a stacked bar graph in the form of a circle, where the x axis extends horizontally along the full diameter of the circle and the y axis extends vertically, and then displays data within the circle so the data is proportionally represented within the circle.

19. The graphic display object of claim 16 wherein a proportion of different patterns or colors is determined according to the area of the circle and then displayed them stacked along the horizontal axis.

20. The graphic display object of claim 16 representing compiled state information from an individual or groups of individuals to display the proportion of respondents according to their choice

21. The graphic display object of claim 16 additionally comprising:
solid colors or combinations of colors in the object arranged along a top to bottom axis.

22. An apparatus to collect and display facts that support human perceptions in the context of a real time dynamic model of a network of event nodes comprising:
a data object having an input and a state used to encode data to indicate the state of facts that support perceptions an activity.

23. An apparatus as in claim 22 wherein the mechanism encodes three possible states of change related to the factual data.

24. An apparatus as in claim 23 wherein a graphical rendering of the state of the data objects is a representation of links between objects displayed as red (or black) hammerhead lines, green (or black) solid lines with or without arrowheads, or dashed blue (or black) lines with or without arrowheads.

25. An apparatus as in claim 22 wherein the object represents a direction of change towards a desired or undesired state.

26. An apparatus as in claim 22 wherein the object enables the detection of the state of change prior to potentially catastrophic events or advantageous opportunities.

27. The graphic display object of claim 16 wherein the sphere is bisected along an interior portion thereof to further illustrate relationships among survey responses.

28. A method as in claim 1 wherein the process is used as a conflict resolution procedure.

29. A data processing apparatus used to collect and display suggestions or opportunities for action in the context of a real time dynamic model of a network of event nodes the apparatus, comprising:
a data object having an input and states representation to encode data to indicate a change in status of an opportunity.

30. An apparatus as in claim 29 wherein the state mechanism is used to encode three possible states of change of the opportunity.

31. An apparatus as in claim 29 wherein a graphical rendering of the state mechanism is a representation of links between objects displayed as dotted or black lines with or without arrowheads

32. An apparatus as in claim 29 wherein the object represents a direction of change towards a desired or undesired state.

33. An apparatus as in claim 29 wherein the object enables the detection of the state of change prior to potentially catastrophic events or advantageous opportunities.

34. An apparatus used to collect and display tasks selected for action in the context of a real time dynamic model of a network of event nodes comprising:
a data object having an input and state mechanism used to encode data to indicate a change in status of an action.

35. An apparatus as in claim 34 wherein the mechanism encodes a number of different states of change related to the action according to data displayed for different process steps.

36. An apparatus as in claim 34 wherein a graphical rendering of the state mechanism is a representation of links between objects displayed as lines composed of alternating dots and dashes with or without arrowheads.

37. An apparatus as in claim 34 wherein the object represents a direction of change towards a desired or undesired state.

38. An apparatus as in claim 34 wherein the object enables the detection of the state of change prior to potentially catastrophic events or advantageous opportunities (prompting adaptive rather than reactive behavior).

39. An apparatus sued to collect and display knowledge assets as combinations of connections and/or opportunities for action in the context of a real time dynamic model of a network of event nodes comprising:
a data object having an input and state mechanism to encode data to indicate a change in status of knowledge assets.

40. An apparatus as in claim 39 wherein the mechanism encodes three possible states of change of the knowledge assets.

41. An apparatus as in claim 39 wherein a graphical rendering of the switching mechanism is a representation of links between three spheres displayed as solid lines with or without arrowheads.

42. An apparatus as in claim 39 wherein the object represents a direction of change towards a desired or undesired state.

43. An apparatus as in claim 39 wherein the object enables the detection of the state of change prior to potentially catastrophic events or advantageous opportunities that could affect the status of knowledge assets.

44. A data processing system in which computerized data objects are used to encode human response information so that such information can be utilized by a distributed network of data processing devices, the system thus providing an actionable feedback system to improve the reasoning of participants in an organizational decision making process.

45. A system as in claim 44 wherein the participants may view a graphical representation of their collective reasoning.

46. A system as in claim 45 in which the data objects represent information for participants derived from self-assessment questions.

47. A system as in claim 45 in which the data objects represent information for participants derived from their own compiled data.

48. A system as in claim 45 in which the data objects represent information for users of the system derived from a database of prior records.

49. A system as in claim 45 in which participants can monitor and track change in patterns of interaction among influence objects.

50. A system as in claim 45 in which participants can update the database as the state of events change.

51. A system as in claim 45 in which participants can update the database with new survey responses.

52. A system as in claim 44 wherein participants may view a measure of the evolution of their collective reasoning over time from an historical database.

53. A system as in claim 52 in which the data objects represent historical data for users of the system derived from self-assessment.

54. A system as in claim 52 in which the data objects represent historical data for users of the system derived from patterns detected in their own compiled historical data.

55. A system as in claim 52 in which the data objects represent historical information for users of the system derived from historical data other than their own.

56. A system as in claim 52 in which participants can monitor and track changes in the historical database.

57. A system as in claim 52 which tracks changes in the historical data as actions get completed or blocked.

58. A system as in claim 52 used to track changes to the historical database from new survey responses.

59. A system as in claim 52 wherein participants can get confidential feedback that shows their views in relation to other individual who have given permission to view their data.

60. A system as in claim 59 wherein participants can get confidential feedback that shows their views in relation to other organizational groups.

61. A system as in claim 59 wherein participants can get confidential feedback that shows their views in relation to work systems or business units.

62. A system as in claim 59 wherein participants can get confidential feedback that shows their data in relation to cross-functional teams.

63. A system as in claim 59 wherein participants can get confidential feedback that shows their data in relation to executive decision-makers.

64. A system as in claim 59 wherein participants can get confidential feedback that shows their data in relation to all the other members of the organization.

65. A process for aiding collaborative decision making, the process executing within a data processing system, comprising the steps of:
gathering individual survey responses to survey elements from each member of a group of people involved in the collaborative decision making;
representing the individual survey responses in an influence object format that represents both the individual survey responses as well as relationships between the individual responses; and
providing a graphical display of the state of individual survey responses as represented in the influence objects and relationships between the influence objects using a common graphical model.

66. A method as in claim 65 wherein the step of gathering survey responses is performed in a network of computers, with the members of the group providing their individual survey responses through respective client computer systems.

67. A method as in claim 65 wherein the survey elements incorporate an open-ended question model that encourages survey responses that can be categorized in predefined possible reponses.

68. A method as in claim 65 additionally comprising the steps of:
specifying an automatic logic model process is specified according to decision logic functions, the logic model process being used to analyze the influence objects.

69. A method as in claim 65 wherein subject areas for the influence objects are selected from a lexicon consisting of key words for leadership, marketing, strategy, finance, operations, sales, structure, culture, development, staffing and customer activities.

70. A method as in claim 65 wherein the common graphical model further comprises an influence perception map that includes a graphical display of the state of the influence objects having a predetermined spatial pattern with respect to one another.

71. A method as in claim 70 wherein the spatial pattern for visualizing the influence objects has been statistically derived from a frequency distribution of interactions reported.

72. A method as in claim 70 wherein the graphical representation of the influence objects are spheres.

73. A method as in claim 70 wherein the states of the individual influence objects are represented as different colors.

74. A method as in claim 73 wherein the states of the individual influence objects are represented as a traffic light, wherein the the colors red, yellow and green represent, respectively, a range of responses to survey questions indicating a status of trouble, status quo or no problems reported.

75. A method as in claim 70 wherein relationships between the influence objects are graphically represented as links between the graphical representations of the corresponding influence objects.

76. A method as in claim 75 wherein the links represent a rate, level or direction of interactivty between specified influence objects.

77. A method as in claim 75 wherein the links are rendering graphically as a line with varying thicknes, wherein the thickness of the line indicates how many survey responses fall into a particular category.

78. A method as in claim 75 wherein the links are selected from the group consisting of a positive link or connection, and a negative link or block.

79. A method as in claim 78 wherein the positive links are represented as a black line and a negative link as a black hammer.

80. A method as in claim 70 additionally comprising the step of:
providing a reflection map that represents a compilation of two or more influence maps, wherein the states of the compiled influence objects are responses graphically as spheres, with portions of the spheres colored to indicate the number of responses of a particular type for each possible state of the corresponding influence object.

81. A method as in claim 70 additionally comprising the step of:
providing a hemisphere map that represents a level of congruence or divergence between two influence maps, different data sets, the hemisphere map dividing a graphical representation of a sphere along a vertical diameter into two hemispheres, with a hemisphere devoted to each data set.

82. A method as in claim 81 wherein portions of the hemispheres are colored to indicate the number of responses of a particular type for each possible state of the corresponding influence object from the respective data set.

83. A method as in claim 75 additionally comprising the step of:
providing a circuit board map that represents compiled individual influence maps, with compiled corresponding connections and blocks rendered as lines or hammers with a varying visual attribute.

84. A method as in claim 83 wherein the varying visual attribute of the link is selected from the group consisting of line thickness and line color.
